(19) United States
(12) Patent Application Publication
(10) Pub. No.: US 2005/0081057 A1
(43) Pub. Date: Apr. 14, 2005

(54) Method and system for preventing exploiting an email message

(76) Inventors: Oded Cohen, Tivon (IL); Yanki Margalit, Ramat-Gan (IL); Dany Margalit, Ramat-Gan (IL)

Correspondence Address: DR. MARK FRIEDMAN LTD.;C/o Bill Polkinghorn, Discovery Dispatch, 9003 Florin Way, Upper Marlboro, MD, 20772, US

(21) Appl. No.: 10/681,904

(22) Filed: Oct. 10, 2003

(51) Int. Cl. H04L 9/00

(52) U.S. Cl. 713/201; 709/206

(57) ABSTRACT

The present invention relates to a method for preventing exploiting an email message and a system thereof. The method comprising: decomposing the email message to its components; for each of the components, correcting the structural form (e.g. structure, format, and content) of the component to comply with common rules thereof whenever the structural form of the component deviates from the rules; and recomposing the email message from its components (in their recent state). The rules relate to email messages structure, for preventing malformed structure of email messages, for preventing exploiting an email message, etc. In case where the structural form of the component cannot be identified, the component may not be included within the recomposed email message, or included as is to the recomposed email message.

### FIELD OF THE INVENTION

The present invention relates to the field of preventing email viruses.

### BACKGROUND OF THE INVENTION

The structure of email messages is defined for example in RFCs 2822, 2045-2049. According to the recommendations of these publications, email messages should appear in textual format, i.e. comprise only ASCII characters, contrary to a binary format. Thus the structure of email messages is actually flexible, despite the existence of definitions regarding email structure. Moreover, email clients try to handle deviations from what is considered as standard in order to enable communication between as many email clients as possible.

The relatively free structure may be exploited by “hackers” for introducing hostile content into recipients' computers, mail servers and inspection facilities (i.e. systems for detecting hostile content within email messages) operating between senders and recipients.

FIG. 1 illustrates a simple email message. It comprises three components:
The header: components 11 to 14;
A delimiter row: the empty row 15; and
The message text: marked as 16 to 18.

A “component” may comprise “sub-components”. For example, components 11 to 14 can be considered as the “sub-components” of the email header, and components 16 to 18 can be considered as the sub-components of the email content component.

The delimiter row 15 separates the headers 11 to 14 from the text of the message, which is marked as 16 to 18.

The message comprises four headers:
“From”: the identity of the sender, marked as 11;
“To”: the identity of the recipient, marked as 12;
“Subject”: the subject of the message, marked as 13; and
“Date”: the date the message was sent, marked as 14.

As mentioned above, an email message is supposed to contain only ASCII characters, however usually the email client software (e.g. Outlook Express) will not indicate an error if the received email message comprises non-ASCII characters (“invalid content”). The format of the date when the email message was sent is also not defined and consequently additional characters added to this field will not cause the email client or server to indicate an error.

The term “exploit” refers in the art to an attack on a computer system that takes advantage of a particular vulnerability of the computer system. For example, “buffer overflow attack” is a known bug in a variety of systems. It causes the application to overlay system areas, such as the system stack, thereby gaining control over that system.

FIG. 2 schematically illustrates a buffer overflow attack. The computer memory 20 “holds” an email-client software 21, an email message 22, and a system stack 23. Using a malformed structure of the email message 22, the content of the email message 22 may overwrite the memory allocated for the system stack 23. This is illustrated by the arrow 24, which symbolizes the expansion of the memory required for holding the email message 22. Thus, by inserting computer code in unexpected places of an email message, the code may be executed on the recipient's computer and cause damage. Moreover, since email servers usually comprise an inspection facility, such an exploit can also be used for computers that run inspection facilities, email servers, and so forth.

Another well-known vulnerability of email-related systems is that an inspection facility may not be familiar with a certain structure of email message and consequently allows an attachment to reach the recipient's system (“proprietary encoding type”). This may be exploited for introducing hostile content into the recipient's machine and mail server. For example, Base64 and TNEF are formats for files attached to an email message, however some of the email inspection facilities do not support TNEF. Thus, if an email message sent by Microsoft Outlook uses the TNEF format, an inspection facility that does not support TNEF will not look for hostile content within the attachment and consequently the recipient may receive an un-inspected file. Furthermore, email clients that do not support a certain attachment format do not let their users to use an attached file in this format, and consequently leaving the user helpless in such cases.

FIG. 3 illustrates an email message generated by the Outlook Express email client. A file named FIG0000.BMP is attached to the message. The file is in Base64 format, thus the length of its rows 32 is 76 characters, unless it is the last row. It comprises only one text row 34. The email is a multi-component message, wherein each component is delimited by a boundary row 31. The name of the figure appears in two components 33.

The flexible structure of the message leaves a wide space for exploitation. For example, the name of the attached file appears twice. The following questions are raised: How will a certain email client react if the names are not identical (“contradicting information”)? How will a certain email client react if the rows of the attached file are not in the same size (“malformed attachment”)? How a certain inspection facility will act if despite the fact that the attached file has a BMP extension, which indicates an image file, the attached file is actually an executable file (“file-type masquerading”)? And what will happen when the message is loaded into the memory of the email client, if the length of the date filed is 64K bytes, instead of tens of bytes? And so forth.

With regard to malformed attachments, another well-known problem is that the row length of some email clients, e.g. Microsoft Outlook, is a multiple of 4, e.g. 4, 8, 12, 16, 20, 24, . . . 76 bytes, and so forth. When the actual row length does not comply with this rule, it might be interpreted differently by each email client and mail scanner.

Another well-known problem with regard to email messages is that some email clients, e.g. Microsoft Outlook, add to outgoing email messages fields which are not specified in the emails standards. Usually such fields are directed to a recipient email client, in case where the email client is of the same product as the sender email client (e.g. the sender and the recipient are both of Outlook Express). However, from the sender's point of view, the extra fields may comprise information which he may not want to send to the recipient.

Therefore, it is an object of the present invention to provide a method for preventing exploiting email messages by using uncommon structure thereof.

It is a further object of the present invention to enable an email message to comply with the requirements of a variety of email clients.

It is a still further object of the present invention to prevent sending via email messages information which does not comply with emails standards.

Other objects and advantages of the invention will become apparent as the description proceeds.

### SUMMARY OF THE INVENTION

In one aspect, the present invention relates to a method for preventing exploiting an email message and a system thereof. The method comprising: decomposing the email message to its components; for each of the components, correcting the structural form (e.g. structure, format, and content) of the component to comply with common rules thereof whenever the structural form of the component deviates from the rules; and recomposing the email message from its components (in their recent state). The rules relate to email messages structure, for preventing malformed structure of email messages, for preventing exploiting an email message, etc. In case where the structural form of the component cannot be identified, the component may not be included within the recomposed email message, or included as is to the recomposed email message. The malformed structure of the email messages may be invalid structure of a component, invalid content of a component, contradicting information, malformed attachment, proprietary encoding type, file-type masquerading, and so forth.

In another aspect, the present invention is directed to a system for preventing exploiting an email message. The system comprises: a module for identifying the components of an email message; a module for testing the compliance of the structural form of the email message with common rules thereof; a module for correcting the structural form of the email message; and a module for recomposing the email message from its components in their recent state. The system may further comprise a module for detecting hostile content within said components. The system is hosted by a hosting platform, such as an email client, an add-in to an email client, an email server, an add-in to an email server, an appliance, and so forth.

### BRIEF DESCRIPTION OF THE DRAWINGS

The present invention may be better understood in conjunction with the following figures:

FIG. 1 illustrates a simple email message;

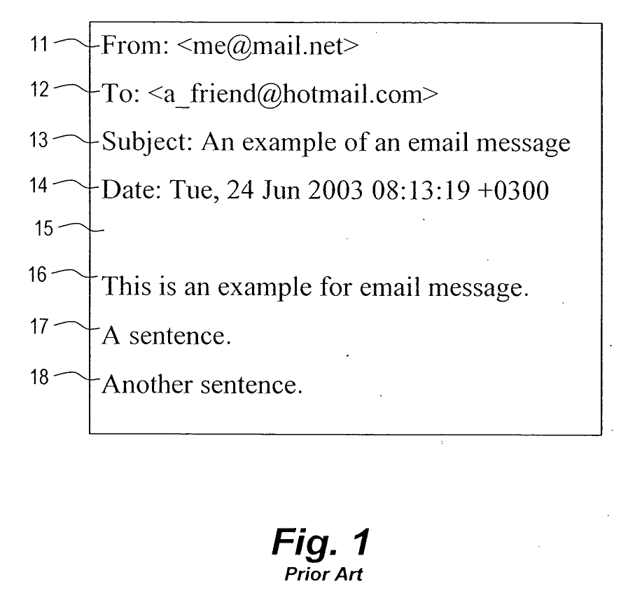

FIG. 2 schematically illustrates a buffer overflow attack;

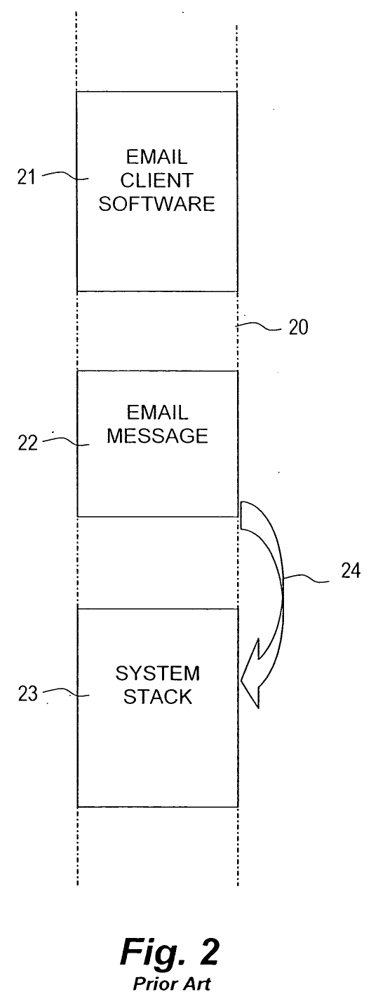

FIG. 3 illustrates an email message generated by the Outlook Express email client; and

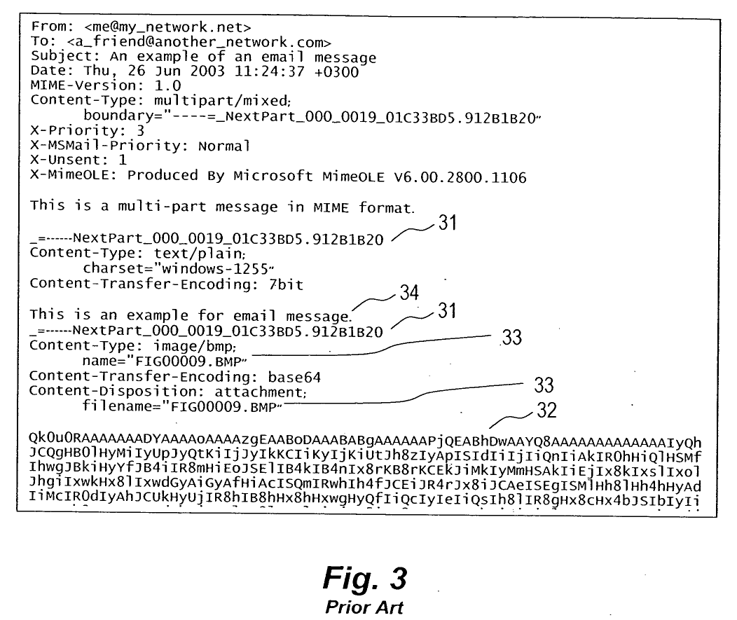

FIG. 4 is a high-level flowchart of a process for preventing exploitation of an email message, according to a preferred embodiment of the invention.

FIG. 5 schematically illustrates the modules of a system for preventing exploitation of an email message, according to a preferred embodiment of the invention.

FIG. 6 schematically illustrates a layout of a mail system in which a system for preventing exploitation of an email message is implemented.

### DETAILED DESCRIPTION OF PREFERRED EMBODIMENTS

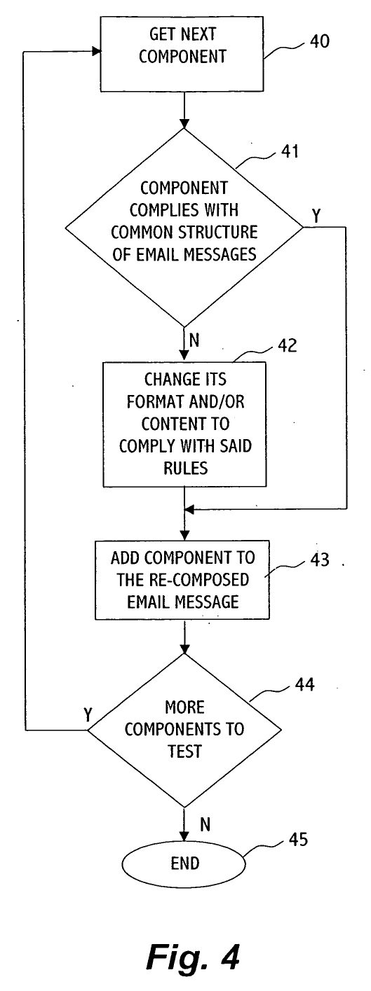

FIG. 4 is a high-level flowchart of a process of preventing exploitation of an email message, according to a preferred embodiment of the invention. It describes a loop in which all the components of the email message are tested.

At block 40, the next component is “fetched” from the email message. (At the first time that block 40 is executed with regard to an email message, the “next” component is the first component of the email message according to their order in the email message.)

At the next block 41, which is a decision block, the subject of the compliance of the email structure with common email structure is questioned. For example, does the content of the component comprise only ASCII characters? Or, in case where the component refers to one or more email addresses, do the component and its content comply with the common structure of email address? And so forth.

From block 41, if the component and its content comply with the common structure of email then flow continues with block 43, otherwise the flow continues with block 42.

At block 42, the component is re-constructed such that its structure and content will comply with the common structure of email messages. For example, if the string comprises non-ASCII characters, then theses characters are removed or replaced with spaces, or if the length of component string is not reasonable for the content (e.g. 200 characters for a date), then the extra characters will be removed, and so forth.

At block 43, the changed component (or unchanged component, in case it complies with the common structure of email messages) is added to the re-constructed email message.

From block 44, if there are more components to be processed, then flow continues with block 40, otherwise the process goes to block 45, where it ends.

If the content of a component is not common structure of email messages, then the component is not added to the recomposed email message.

Of course, the components of the email message can be tested for presence of hostile content.

As mentioned above, a well-known vulnerability of email-related systems is the length of some of the formats, which, for example, at Base64 should be a multiple of 4, i.e. 4, 8, 12, 16, 32, 64 bytes, and so forth. According to one embodiment of the present invention, changing the format of the attachment to a valid format, not necessarily Base64, ensures that every email client that supports this format would be able to handle the data. However, there is still some chance that the “valid” attachment will not be interpreted as the invalid origin. There are some solutions to this problem, e.g. recomposing the email component in such a way that the “average” email client (Outlook Express is good example) will interpret the recomposed attachment and the original attachment in the same way. In the worst case, the decomposition modifies the attachment, but then the end user gets the same data that have reached to the scanner. Indeed, it will not be the original attachment, but still a virus can be “filtered”.

Therefore, the present invention provides a method and module for preventing exploiting email messages by using uncommon structure thereof. It also enables an email message to comply with the requirements of a variety of email clients, and also prevents sending via email messages information which does not comply with emails standards, thereby preventing unwanted information to reach to the wrong hands.

The invention may be implemented as a part of an email client, as an add-in to a mail client, as a part of an email server, as an add-in to a mail server, as an appliance (a “black-box” for providing specific functionality, usually as a substitute for software which has to be installed on a hosting system), and so forth. For example, in the Outlook email client the invention may be implemented via an “add-in” module.

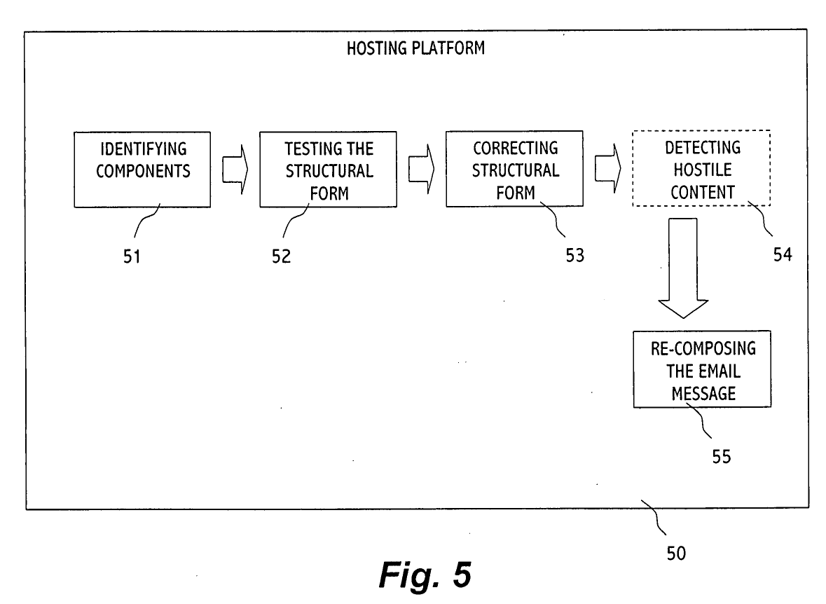

FIG. 5 schematically illustrates the modules of a system for preventing exploitation of an email message, according to a preferred embodiment of the invention. The system is embedded within a hosting platform 50. The hosting platform 50 may be an email client, an add-in to a mail client, a part of an email server, an add-in to a mail server, an appliance (a “black-box” for providing specific functionality, usually as a substitute for software which has to be installed on a hosting system), and so forth. For example, in the Outlook email client the invention may be implemented via an “add-in” module.

The modules of the system for preventing exploitation of an email message 50 may be:
A module for identifying the components of an email message, marked as 51.
A module for testing the compliance of the structural form of said email message with common rules thereof, marked as 52.
A module for correcting the structural form of said email message, marked as 53.
A module for recomposing said email message from its components in their recent state, marked as 55.

In addition, the system for preventing exploitation of an email message 50 may further comprise a module for detecting hostile content within email components 54. Those skilled in the art will appreciate that the hostile content detection may be carried out by a variety of methods known in the art, such as detecting the “signature” of a virus.

Elements 51 to 55 are computerized facilities, e.g. software/hardware modules. When an email message reaches to the hosting platform 50 (e.g. a mail server), the email message is directed to the module for identifying email components 51. Each component is directed to the module for testing the compliance of the structural form 52 of the email message with common rules thereof. If a tested component or its content does not comply with said rules, the component is corrected to comply with these rules. In addition, a component may be tested for presence of hostile code by the module for detecting hostile content 54. This can be carried out by a variety of methods known in the art, such as detecting a virus signature. After a component has been corrected, it is added to the re-composed email message by the module for recomposing an email message from its components 55. Of course elements 51 to 55 may be sub-modules of a single module.

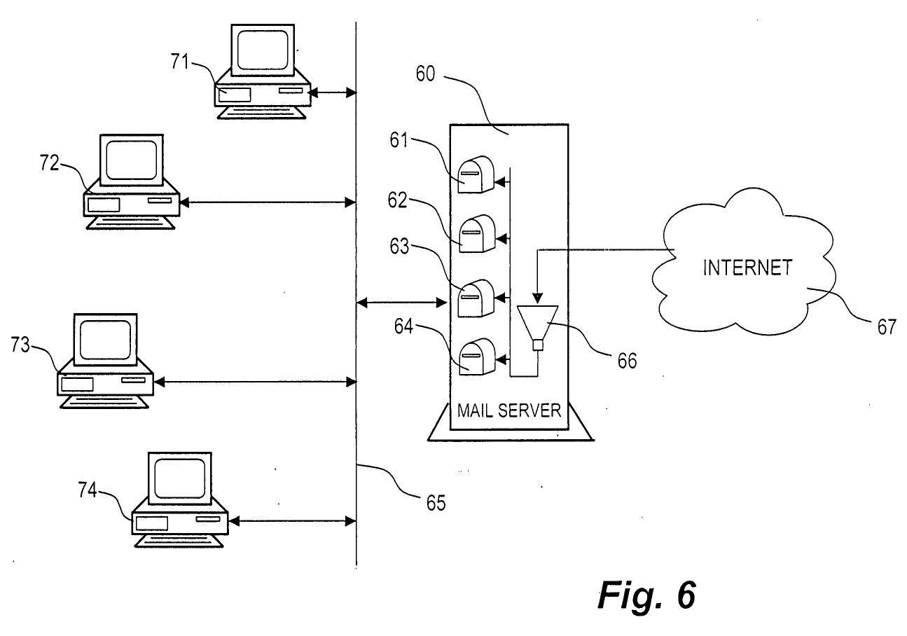

FIG. 6 schematically illustrates a layout of a mail system in which an apparatus for preventing exploitation of an email message is implemented. Users 71-74 are connected through the local area network (LAN) 65 to the email server 60. The email server 60 comprises email boxes 61-64, which belong to users 71-74 respectively. The email server is connected to the Internet 67, through which users 71-74 can exchange email messages with other users worldwide. Of course the users 71-74 can exchange email messages between them, but in this case the connection to the internet is meaningless. The layout described in FIG. 6 differs from the prior art by the presence of a system for preventing exploitation of an email message 66. The system 66 is hosted by the email server 60. An example of the modules of the system 66 is illustrated in FIG. 5.

Those skilled in the art will appreciate that the invention can be embodied by other forms and ways, without losing the scope of the invention. The embodiments described herein should be considered as illustrative and not restrictive.

1. A method for preventing exploiting an email message, comprising:
decomposing said email message to its components;
for each of said components, correcting the structural form of said component to comply with rules thereof, if the structural form of said component deviates from said rules; and
recomposing said email message from components thereof.

2. A method according to claim 1, wherein said rules relate to common structure of an email message.

3. A method according to claim 1, wherein at least one of said rules relates to detecting malformed structure of said email message.

4. A method according to claim 1, wherein at least one of said rules relates to detecting exploits within said email message.

5. A method according to claim 1, wherein said structural form is selected from the group comprising: structure, format, and content.

6. A method according to claim 1, wherein said correcting comprises omitting components that violate said rules from said recomposing.

7. A method according to claim 1, further comprising detecting hostile content within at least one of said components.

8. A method according to claim 3, wherein said malformed structure of an email message is selected from the group including: invalid structure of a component, invalid content of a component, contradicting information, malformed attachment, proprietary encoding type, and file-type masquerading.

9. A system for preventing exploiting an email message, said system implemented at a hosting platform, said system comprising:
a module for identifying components of an email message;
a module for testing a compliance of the structural form of said email message with rules thereof;
a module for correcting the structural form of said email message; and
a module for recomposing said email message from components thereof.

10. A system according to claim 9, wherein said rules relate to common structure of an email message.

11. A system according to claim 9, wherein at least one of said rules relates to detecting malformed structure of said email message.

12. A system according to claim 9, wherein at least one of said rules relates to detecting exploits within said email message.

13. A system according to claim 9, wherein said structural form is selected from the group consisting of: structure, format, and content.

14. A system according to claim 9, further comprising a module for detecting hostile content within said components.
